(19) United States
(12) Patent Application Publication
(10) Pub. No.: US 2024/0051569 A1
(43) Pub. Date: Feb. 15, 2024

(54) LONG-TERM EVOLUTION COMPUTING PLATFORM FOR AUTONOMOUS VEHICLES BASED ON SHELL AND NUT ARCHITECTURE

(71) Applicant: Baidu USA LLC, Sunnyvale, CA (US)

(72) Inventor: Qiang WANG, Cupertino, CA (US)

(21) Appl. No.: 17/885,052

(22) Filed: Aug. 10, 2022

(51) Int. Cl. B60W 60/00

(52) U.S. Cl. CPC B60W 60/001; B60W 2554/4049

(57) ABSTRACT

In one embodiment, a secondary component of a primary-secondary autonomous driving system includes a plurality of sensors configured to sense a surrounding environment of an autonomous driving vehicle (ADV). The secondary component includes a low power compute unit (LPCU) configured to: obtain sensor data from the plurality of sensors, synchronize and preprocess the sensor data to obtain processed sensor data, and detect obstacles using a machine learning pipeline for assistive driving operations. The secondary component includes a microcontroller configured to send control commands to a control system of the ADV, where the control commands are generated by the LPCU or by a high power compute unit (HPCU) of a primary component of the primary-secondary autonomous driving system.

### TECHNICAL FIELD

Embodiments of the present disclosure relate generally to operating autonomous driving vehicles. More particularly, embodiments of the disclosure relate to a long-term evolution computing platform for autonomous vehicles based on primary and secondary architecture.

### BACKGROUND

Vehicles operating in an autonomous mode (e.g., driverless) can relieve occupants, especially the driver, from some driving-related responsibilities. When operating in an autonomous mode, the vehicle can navigate to various locations using onboard sensors, allowing the vehicle to travel with minimal human interaction or in some cases without any passengers.

A robust computing platform to operate an autonomous driving system (ADS) is critical for fast deployment of the autonomous driving vehicle (ADV). When newer and more powerful computing systems become available, the computing platform of the ADS is usually redesigned with the more powerful system so additional computing resources can be available to the ADS.

Different levels (L0 to L5) of autonomous driving

Level 0: The driver (human) controls it all: steering, brakes, throttle, power.

Level 1: This driver-assistance level means that most functions are still controlled by the driver, but a specific function (like steering or accelerating) can be performed automatically by the vehicle.

Level 2: At least one driver assistance system of “both steering and acceleration/deceleration using information about the driving environment” is automated, like cruise control and lane-centering. It means that the “driver is disengaged from physically operating the vehicle by having his or her hands off the steering wheel and foot off pedal at the same time.” The driver must still always be ready to take control of the vehicle, however.

Level 3: Drivers are still necessary in a level 3 vehicle, but are able to completely shift “safety-critical functions” to the vehicle, under certain traffic or environmental conditions. It means that the driver is still present and will intervene if necessary, but is not required to monitor the situation in the same way it does for the previous levels.

Level 4: This is what is meant by “fully autonomous.” Level 4 vehicles are “designed to perform all safety-critical driving functions and monitor roadway conditions for an entire trip.” However, it's important to note that this is limited to the “operational design domain (ODD)” of the vehicle—meaning it does not cover every driving scenario.

Level 5: This refers to a fully-autonomous system that expects the vehicle's performance to equal that of a human driver, in every driving scenario—including extreme environments like dirt roads that are unlikely to be navigated by driverless vehicles in the near future.

### BRIEF DESCRIPTION OF THE DRAWINGS

Embodiments of the disclosure are illustrated by way of example and not limitation in the figures of the accompanying drawings in which like references indicate similar elements.

FIG. 1 is a block diagram illustrating a networked system according to one embodiment.

FIG. 2 is a block diagram illustrating an example of an autonomous driving vehicle according to one embodiment.

FIGS. 3A-3B are block diagrams illustrating an example of an autonomous driving system used with an autonomous driving vehicle according to one embodiment.

FIG. 4 is a block diagram illustrating system architecture for autonomous driving according to one embodiment.

FIGS. 5A-5B are block diagrams illustrating an example of a sensor system according to one embodiment.

FIG. 6 is a block diagram illustrating a computing platform based on the primary and secondary architecture according to one embodiment.

### DETAILED DESCRIPTION

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosures.

Reference in the specification to “one embodiment” or “an embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

According to some embodiments, a computing platform for the autonomous driving vehicle (ADV) includes a primary computing system for the autonomous driving system (ADS) of the ADV and a segregated secondary computing system for sensors and control systems of the ADV under a primary-secondary architecture. Using the primary-secondary architecture, the primary computing system that handles the ADS functions can be upgraded or swapped out quickly without a redesign to the secondary computing system that handles the perception and control.

The current processing requirements for L4/L5 autonomous driving is not well defined across the industry, or the computing platform that supports the implementations of the ADS may be periodically upgraded. The separation of the ADS from the perception/sensor and control systems of the ADS, e.g., camera, LiDAR/radar, GPS, etc., would allow the ADS to be upgraded without changes to the perception and control systems.

Embodiments of the disclosure aim to separate the computing platform for L2/L3 vehicle and L4/L5 using a primary and secondary architecture. The secondary component can contain all sensors for perception functions, a low power computing unit, with low latency, that meets the L2/L3 computing needs for safety and vehicle control and be able to process ADS commands. The primary component can represent a “deep” cognition layer and can be upgraded via the IT industries processes.

According to a first aspect, a secondary component of a primary-secondary autonomous driving system is disclosed. The secondary component includes a plurality of sensors configured to sense a surrounding environment of an autonomous driving vehicle (ADV). The secondary component includes a low power compute unit (LPCU) configured to: obtain sensor data from the plurality of sensors, synchronize and preprocess the sensor data to obtain processed sensor data, and detect obstacles using a machine learning pipeline for assistive driving operations. The secondary component includes a microcontroller configured to send control commands to a control system of the ADV, where the control commands are generated by the LPCU or by a high power (e.g., high speed) compute unit (HPCU) of a primary component of the primary-secondary autonomous driving system.

In one embodiment, the LPCU has low latency, low level cognition, low power consumption and a low failure rate.

In one embodiment, the LPCU performs at least one of: assisted cruise control, lane guidance, or autonomous parking.

In one embodiment, the secondary component is communicatively coupled to the primary via a high speed link, wherein the high speed link includes a compute express link (CXL) interface.

In one embodiment, the secondary component is communicatively coupled to the primary via wireless cellular communication.

In one embodiment, the secondary component further includes a memory buffer, wherein the sensor data are stored in the memory buffer in a first-in-first-out manner.

In one embodiment, the memory buffer includes a circular memory buffer, wherein the primary component replaces control commands on the LCPU circular memory buffer before the commands are sent to the microcontroller.

In one embodiment, the data in a memory buffer is transferred to the primary component via a publish and subscribe protocol.

In one embodiment, the LPCU comprises at least one of: a field programmable gate array (FPGA), a system on a chip (SOC), or an edge device.

In one embodiment, the LPCU is operable independent of the primary component to provide driver assist features to the ADV.

According to a second aspect, a primary-secondary autonomous driving system includes a primary component and a secondary component coupled to the primary component via a high speed link. The primary component includes a high power compute unit (HPCU) and the HPCU includes one or more processors, and a memory coupled to the one or more processors to perform autonomous driving operations. The secondary component includes a plurality of sensors configured to sense a surrounding environment of an autonomous driving vehicle (ADV). The secondary component includes a low power compute unit (LPCU) configured to: obtain sensor data from the plurality of sensors, synchronize and preprocess the sensor data to obtain processed sensor data, and detect obstacles using a machine learning pipeline for assistive driving operations. The secondary component includes a microcontroller configured to send control commands to a control system of the ADV, where the control commands are generated by the LPCU or by the HPCU of the primary component.

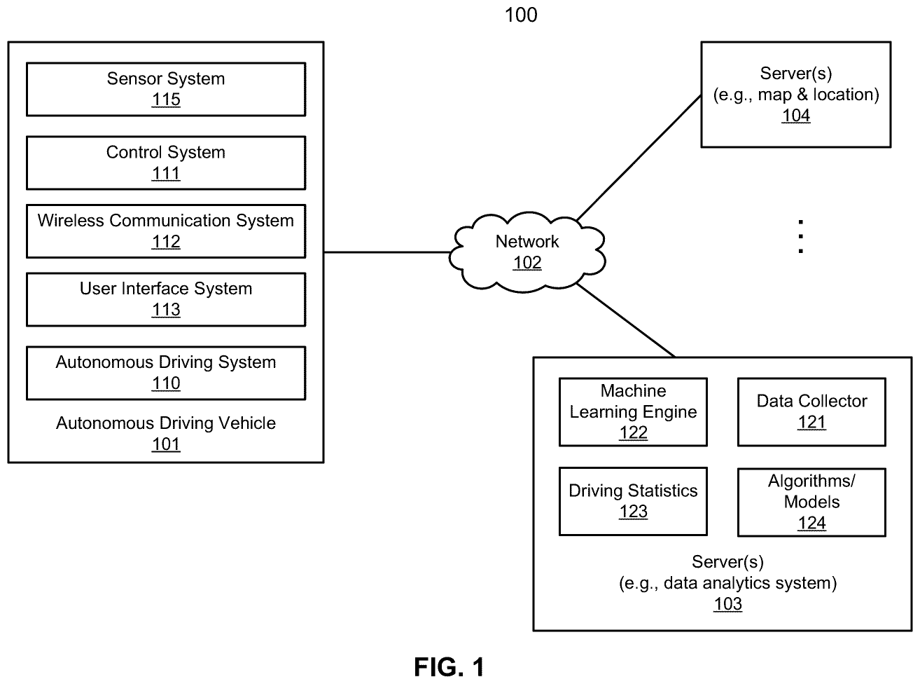

FIG. 1 is a block diagram illustrating an autonomous driving network configuration according to one embodiment of the disclosure. Referring to FIG. 1, network configuration 100 includes autonomous driving vehicle (ADV) 101 that may be communicatively coupled to one or more servers 103-104 over a network 102. Although there is one ADV shown, multiple ADVs can be coupled to each other and/or coupled to servers 103-104 over network 102. Network 102 may be any type of networks such as a local area network (LAN), a wide area network (WAN) such as the Internet, a cellular network, a satellite network, or a combination thereof, wired or wireless. Server(s) 103-104 may be any kind of servers or a cluster of servers, such as Web or cloud servers, application servers, backend servers, or a combination thereof. Servers 103-104 may be data analytics servers, content servers, traffic information servers, map and point of interest (MPOI) servers, or location servers, etc.

An ADV refers to a vehicle that can be configured to in an autonomous mode in which the vehicle navigates through an environment with little or no input from a driver. Such an ADV can include a sensor system having one or more sensors that are configured to detect information about the environment in which the vehicle operates. The vehicle and its associated controller(s) use the detected information to navigate through the environment. ADV 101 can operate in a manual mode, a full autonomous mode, or a partial autonomous mode.

In one embodiment, ADV 101 includes, but is not limited to, autonomous driving system (ADS) 110, vehicle control system 111, wireless communication system 112, user interface system 113, and sensor system 115. ADV 101 may further include certain common components included in ordinary vehicles, such as, an engine, wheels, steering wheel, transmission, etc., which may be controlled by vehicle control system 111 and/or ADS 110 using a variety of communication signals and/or commands, such as, for example, acceleration signals or commands, deceleration signals or commands, steering signals or commands, braking signals or commands, etc.

Components 110-115 may be communicatively coupled to each other via an interconnect, a bus, a network, or a combination thereof. For example, components 110-115 may be communicatively coupled to each other via a controller area network (CAN) bus. A CAN bus is a vehicle bus standard designed to allow microcontrollers and devices to communicate with each other in applications without a host computer. It is a message-based protocol, designed originally for multiplex electrical wiring within automobiles, but is also used in many other contexts.

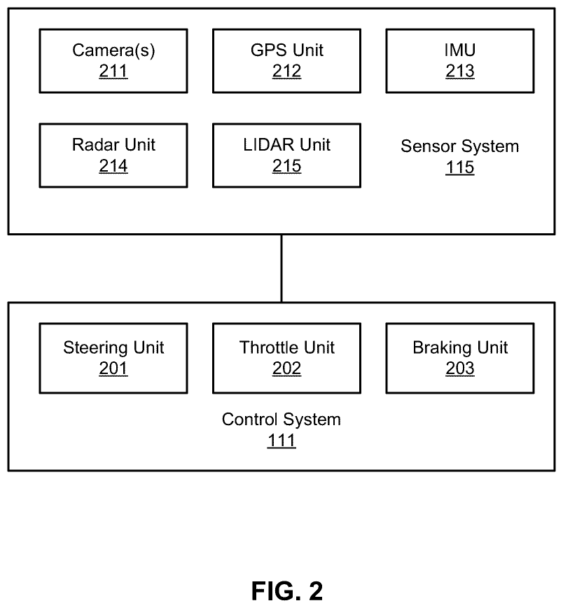

Referring now to FIG. 2, in one embodiment, sensor system 115 includes, but it is not limited to, one or more cameras 211, global positioning system (GPS) unit 212, inertial measurement unit (IMU) 213, radar unit 214, and a light detection and range (LIDAR) unit 215. GPS system 212 may include a transceiver operable to provide information regarding the position of the ADV. IMU unit 213 may sense position and orientation changes of the ADV based on inertial acceleration. Radar unit 214 may represent a system that utilizes radio signals to sense objects within the local environment of the ADV. In some embodiments, in addition to sensing objects, radar unit 214 may additionally sense the speed and/or heading of the objects. LIDAR unit 215 may sense objects in the environment in which the ADV is located using lasers. LIDAR unit 215 could include one or more laser sources, a laser scanner, and one or more detectors, among other system components. Cameras 211 may include one or more devices to capture images of the environment surrounding the ADV. Cameras 211 may be still cameras and/or video cameras. A camera may be mechanically movable, for example, by mounting the camera on a rotating and/or tilting a platform.

Sensor system 115 may further include other sensors, such as, a sonar sensor, an infrared sensor, a steering sensor, a throttle sensor, a braking sensor, and an audio sensor (e.g., microphone). An audio sensor may be configured to capture sound from the environment surrounding the ADV. A steering sensor may be configured to sense the steering angle of a steering wheel, wheels of the vehicle, or a combination thereof. A throttle sensor and a braking sensor sense the throttle position and braking position of the vehicle, respectively. In some situations, a throttle sensor and a braking sensor may be integrated as an integrated throttle/braking sensor.

In some embodiments, sensor system 115 include vehicle to everything (V2X) sensors that can capture data from nearby entities (vehicles, pedestrians, devices, networks) or infrastructures (traffic lights, roads, etc.).

In one embodiment, vehicle control system 111 includes, but is not limited to, steering unit 201, throttle unit 202 (also referred to as an acceleration unit), and braking unit 203. Steering unit 201 is to adjust the direction or heading of the vehicle. Throttle unit 202 is to control the speed of the motor or engine that in turn controls the speed and acceleration of the vehicle. Braking unit 203 is to decelerate the vehicle by providing friction to slow the wheels or tires of the vehicle. Note that the components as shown in FIG. 2 may be implemented in hardware, software, or a combination thereof.

Referring back to FIG. 1, wireless communication system 112 is to allow communication between ADV 101 and external systems, such as devices, sensors, other vehicles, etc. For example, wireless communication system 112 can wirelessly communicate with one or more devices directly or via a communication network, such as servers 103-104 over network 102. Wireless communication system 112 can use any cellular communication network or a wireless local area network (WLAN), e.g., using WiFi to communicate with another component or system. Wireless communication system 112 could communicate directly with a device (e.g., a mobile device of a passenger, a display device, a speaker within vehicle 101), for example, using an infrared link, Bluetooth, etc. User interface system 113 may be part of peripheral devices implemented within vehicle 101 including, for example, a keyboard, a touch screen display device, a microphone, and a speaker, etc.

Some or all of the functions of ADV 101 may be controlled or managed by ADS 110, especially when operating in an autonomous driving mode. ADS 110 includes the necessary hardware (e.g., processor(s), memory, storage) and software (e.g., operating system, planning and routing programs) to receive information from sensor system 115, control system 111, wireless communication system 112, and/or user interface system 113, process the received information, plan a route or path from a starting point to a destination point, and then drive vehicle 101 based on the planning and control information. Alternatively, ADS 110 may be integrated with vehicle control system 111.

For example, a user as a passenger may specify a starting location and a destination of a trip, for example, via a user interface. ADS 110 obtains the trip related data. For example, ADS 110 may obtain location and route data from an MPOI server, which may be a part of servers 103-104. The location server provides location services and the MPOI server provides map services and the POIs of certain locations. Alternatively, such location and MPOI information may be cached locally in a persistent storage device of ADS 110.

While ADV 101 is moving along the route, ADS 110 may also obtain real-time traffic information from a traffic information system or server (TIS). Note that servers 103-104 may be operated by a third party entity. Alternatively, the functionalities of servers 103-104 may be integrated with ADS 110. Based on the real-time traffic information, MPOI information, and location information, as well as real-time local environment data detected or sensed by sensor system 115 (e.g., obstacles, objects, nearby vehicles), ADS 110 can plan an optimal route and drive vehicle 101, for example, via control system 111, according to the planned route to reach the specified destination safely and efficiently.

Server 103 may be a data analytics system to perform data analytics services for a variety of clients. In one embodiment, data analytics system 103 includes data collector 121 and machine learning engine 122. Data collector 121 collects driving statistics 123 from a variety of vehicles, either ADVs or regular vehicles driven by human drivers. Driving statistics 123 include information indicating the driving commands (e.g., throttle, brake, steering commands) issued and responses of the vehicles (e.g., speeds, accelerations, decelerations, directions) captured by sensors of the vehicles at different points in time. Driving statistics 123 may further include information describing the driving environments at different points in time, such as, for example, routes (including starting and destination locations), MPOIs, road conditions, weather conditions, etc.

Based on driving statistics 123, machine learning engine 122 generates or trains a set of rules, algorithms, and/or predictive models 124 for a variety of purposes. In one embodiment, models 124 may include machine learning models for decision making and route planning.

Algorithms 124 can then be uploaded on ADVs to be utilized during autonomous driving in real-time.

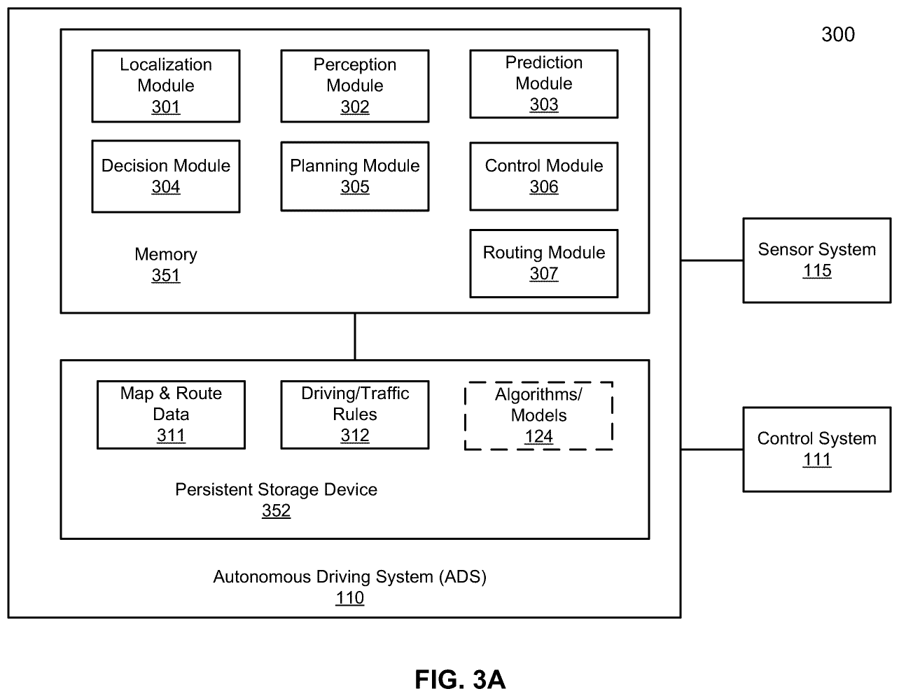

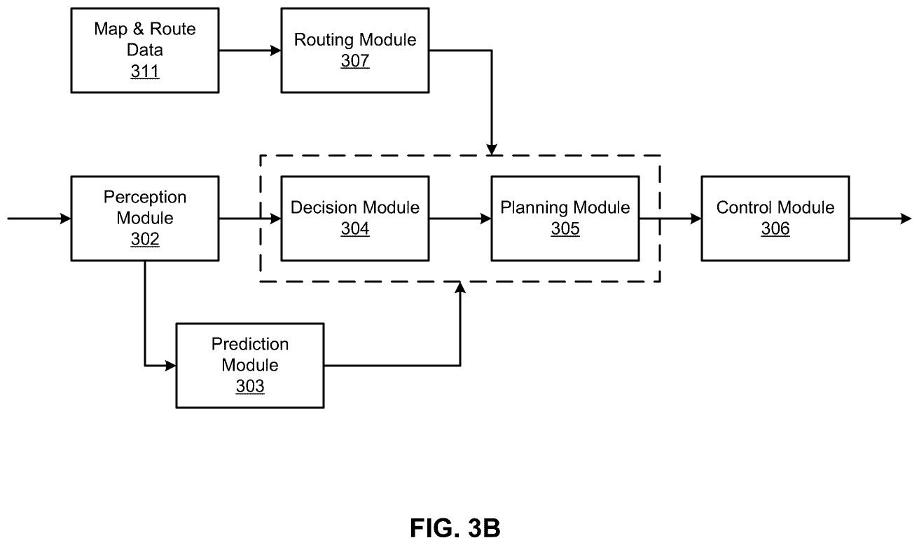

FIGS. 3A and 3B are block diagrams illustrating an example of an autonomous driving system used with an ADV according to one embodiment. System 300 may be implemented as a part of ADV 101 of FIG. 1 including, but is not limited to, ADS 110, control system 111, and sensor system 115. Referring to FIGS. 3A-3B, ADS 110 includes, but is not limited to, localization module 301, perception module 302, prediction module 303, decision module 304, planning module 305, control module 306, and routing module 307.

Some or all of modules 301-307 may be implemented in software, hardware, or a combination thereof. For example, these modules may be installed in persistent storage device 352, loaded into memory 351, and executed by one or more processors (not shown). Note that some or all of these modules may be communicatively coupled to or integrated with some or all modules of vehicle control system 111 of FIG. 2. Some of modules 301-307 may be integrated together as an integrated module.

Localization module 301 determines a current location of ADV 300 (e.g., leveraging GPS unit 212) and manages any data related to a trip or route of a user. Localization module 301 (also referred to as a map and route module) manages any data related to a trip or route of a user. A user may log in and specify a starting location and a destination of a trip, for example, via a user interface. Localization module 301 communicates with other components of ADV 300, such as map and route data 311, to obtain the trip related data. For example, localization module 301 may obtain location and route data from a location server and a map and POI (MPOI) server. A location server provides location services and an MPOI server provides map services and the POIs of certain locations, which may be cached as part of map and route data 311. While ADV 300 is moving along the route, localization module 301 may also obtain real-time traffic information from a traffic information system or server.

Based on the sensor data provided by sensor system 115 and localization information obtained by localization module 301, a perception of the surrounding environment is determined by perception module 302. The perception information may represent what an ordinary driver would perceive surrounding a vehicle in which the driver is driving. The perception can include the lane configuration, traffic light signals, a relative position of another vehicle, a pedestrian, a building, crosswalk, or other traffic related signs (e.g., stop signs, yield signs), etc., for example, in a form of an object. The lane configuration includes information describing a lane or lanes, such as, for example, a shape of the lane (e.g., straight or curvature), a width of the lane, how many lanes in a road, one-way or two-way lane, merging or splitting lanes, exiting lane, etc.

Perception module 302 may include a computer vision system or functionalities of a computer vision system to process and analyze images captured by one or more cameras in order to identify objects and/or features in the environment of the ADV. The objects can include traffic signals, road way boundaries, other vehicles, pedestrians, and/or obstacles, etc. The computer vision system may use an object recognition algorithm, video tracking, and other computer vision techniques. In some embodiments, the computer vision system can map an environment, track objects, and estimate the speed of objects, etc. Perception module 302 can also detect objects based on other sensors data provided by other sensors such as a radar and/or LIDAR.

For each of the objects, prediction module 303 predicts what the object will behave under the circumstances. The prediction is performed based on the perception data perceiving the driving environment at the point in time in view of a set of map/route information 311 and traffic rules 312. For example, if the object is a vehicle at an opposing direction and the current driving environment includes an intersection, prediction module 303 will predict whether the vehicle will likely move straight forward or make a turn. If the perception data indicates that the intersection has no traffic light, prediction module 303 may predict that the vehicle may have to fully stop prior to enter the intersection. If the perception data indicates that the vehicle is currently at a left-turn only lane or a right-turn only lane, prediction module 303 may predict that the vehicle will more likely make a left turn or right turn respectively.

For each of the objects, decision module 304 makes a decision regarding how to handle the object. For example, for a particular object (e.g., another vehicle in a crossing route) as well as its metadata describing the object (e.g., a speed, direction, turning angle), decision module 304 decides how to encounter the object (e.g., overtake, yield, stop, pass). Decision module 304 may make such decisions according to a set of rules such as traffic rules or driving rules 312, which may be stored in persistent storage device 352.

Routing module 307 is configured to provide one or more routes or paths from a starting point to a destination point. For a given trip from a start location to a destination location, for example, received from a user, routing module 307 obtains route and map information 311 and determines all possible routes or paths from the starting location to reach the destination location. Routing module 307 may generate a reference line in a form of a topographic map for each of the routes it determines from the starting location to reach the destination location. A reference line refers to an ideal route or path without any interference from others such as other vehicles, obstacles, or traffic condition. That is, if there is no other vehicle, pedestrians, or obstacles on the road, an ADV should exactly or closely follows the reference line. The topographic maps are then provided to decision module 304 and/or planning module 305. Decision module 304 and/or planning module 305 examine all of the possible routes to select and modify one of the most optimal routes in view of other data provided by other modules such as traffic conditions from localization module 301, driving environment perceived by perception module 302, and traffic condition predicted by prediction module 303. The actual path or route for controlling the ADV may be close to or different from the reference line provided by routing module 307 dependent upon the specific driving environment at the point in time.

Based on a decision for each of the objects perceived, planning module 305 plans a path or route for the ADV, as well as driving parameters (e.g., distance, speed, and/or turning angle), using a reference line provided by routing module 307 as a basis. That is, for a given object, decision module 304 decides what to do with the object, while planning module 305 determines how to do it. For example, for a given object, decision module 304 may decide to pass the object, while planning module 305 may determine whether to pass on the left side or right side of the object. Planning and control data is generated by planning module 305 including information describing how vehicle 101 would move in a next moving cycle (e.g., next route/path segment). For example, the planning and control data may instruct vehicle 101 to move 10 meters at a speed of 30 miles per hour (mph), then change to a right lane at the speed of 25 mph.

Based on the planning and control data, control module 306 controls and drives the ADV, by sending proper commands or signals to vehicle control system 111, according to a route or path defined by the planning and control data. The planning and control data include sufficient information to drive the vehicle from a first point to a second point of a route or path using appropriate vehicle settings or driving parameters (e.g., throttle, braking, steering commands) at different points in time along the path or route.

In one embodiment, the planning phase is performed in a number of planning cycles, also referred to as driving cycles, such as, for example, in every time interval of 100 milliseconds (ms). For each of the planning cycles or driving cycles, one or more control commands will be issued based on the planning and control data. That is, for every 100 ms, planning module 305 plans a next route segment or path segment, for example, including a target position and the time required for the ADV to reach the target position. Alternatively, planning module 305 may further specify the specific speed, direction, and/or steering angle, etc. In one embodiment, planning module 305 plans a route segment or path segment for the next predetermined period of time such as 5 seconds. For each planning cycle, planning module 305 plans a target position for the current cycle (e.g., next 5 seconds) based on a target position planned in a previous cycle. Control module 306 then generates one or more control commands (e.g., throttle, brake, steering control commands) based on the planning and control data of the current cycle.

Note that decision module 304 and planning module 305 may be integrated as an integrated module. Decision module 304/planning module 305 may include a navigation system or functionalities of a navigation system to determine a driving path for the ADV. For example, the navigation system may determine a series of speeds and directional headings to affect movement of the ADV along a path that substantially avoids perceived obstacles while generally advancing the ADV along a roadway-based path leading to an ultimate destination. The destination may be set according to user inputs via user interface system 113. The navigation system may update the driving path dynamically while the ADV is in operation. The navigation system can incorporate data from a GPS system and one or more maps so as to determine the driving path for the ADV.

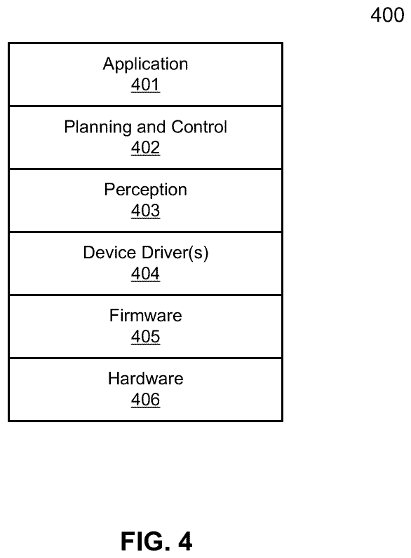

FIG. 4 is a block diagram illustrating system architecture for autonomous driving according to one embodiment. System architecture 400 may represent system architecture of an autonomous driving system as shown in FIGS. 3A and 3B. Referring to FIG. 4, system architecture 400 includes, but it is not limited to, application layer 401, planning and control (PNC) layer 402, perception layer 403, driver layer 404, firmware layer 405, and hardware layer 406. Application layer 401 may include user interface or configuration application that interacts with users or passengers of an autonomous driving vehicle, such as, for example, functionalities associated with user interface system 113. PNC layer 402 may include functionalities of at least planning module 305 and control module 306. Perception layer 403 may include functionalities of at least perception module 302. In one embodiment, there is an additional layer including the functionalities of prediction module 303 and/or decision module 304. Alternatively, such functionalities may be included in PNC layer 402 and/or perception layer 403. System architecture 400 further includes driver layer 404, firmware layer 405, and hardware layer 406. Firmware layer 405 may represent at least the functionality of sensor system 115, which may be implemented in a form of a field programmable gate array (FPGA). Hardware layer 406 may represent the hardware of the autonomous driving vehicle such as control system 111. Layers 401-403 can communicate with firmware layer 405 and hardware layer 406 via device driver layer 404.

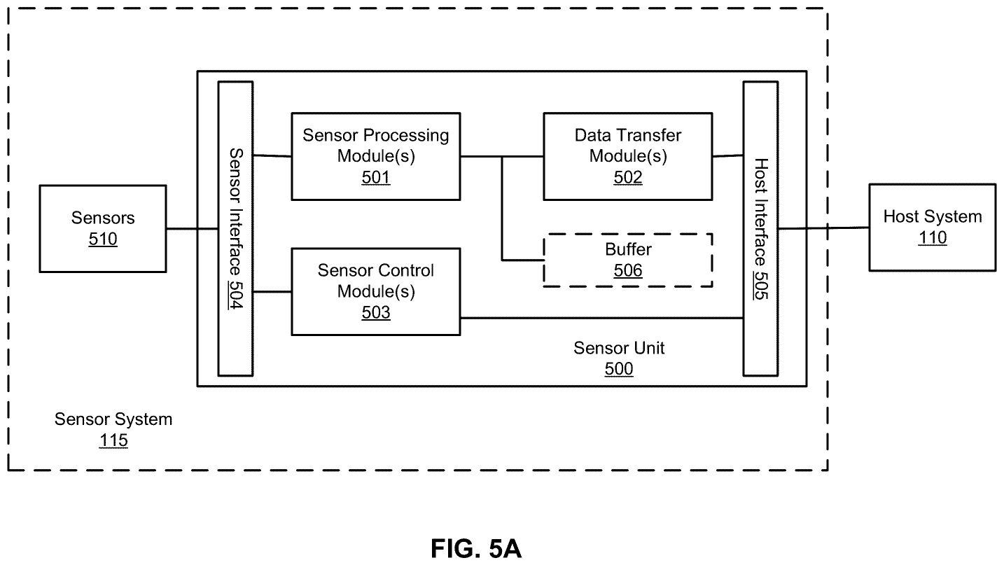

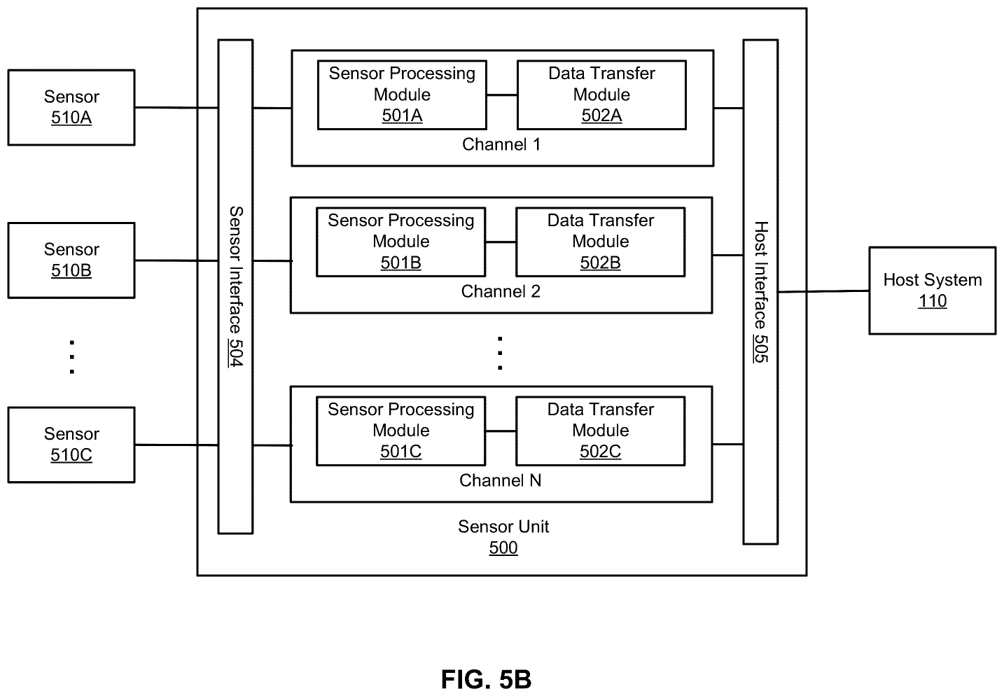

FIG. 5A is a block diagram illustrating an example of a sensor system according to one embodiment of the invention. Referring to FIG. 5A, sensor system 115 includes a number of sensors 510 and a sensor unit 500 coupled to host system 110. Host system 110 represents a planning and control system as described above, which may include at least some of the modules as shown in FIGS. 3A and 3B. Sensor unit 500 may be implemented in a form of an FPGA device or an ASIC (application specific integrated circuit) device. In one embodiment, sensor unit 500 includes, amongst others, one or more sensor data processing modules 501 (also simply referred to as sensor processing modules), data transfer modules 502, and sensor control modules or logic 503. Modules 501-503 can communicate with sensors 510 via a sensor interface 504 and communicate with host system 110 via host interface 505. Optionally, an internal or external buffer 506 may be utilized for buffering the data for processing.

In one embodiment, for the receiving path or upstream direction, sensor processing module 501 is configured to receive sensor data from a sensor via sensor interface 504 and process the sensor data (e.g., format conversion, error checking), which may be temporarily stored in buffer 506. Data transfer module 502 is configured to transfer the processed data to host system 110 using a communication protocol compatible with host interface 505. Similarly, for the transmitting path or downstream direction, data transfer module 502 is configured to receive data or commands from host system 110. The data is then processed by sensor processing module 501 to a format that is compatible with the corresponding sensor. The processed data is then transmitted to the sensor.

In one embodiment, sensor control module or logic 503 is configured to control certain operations of sensors 510, such as, for example, timing of activation of capturing sensor data, in response to commands received from host system (e.g., perception module 302) via host interface 505. Host system 110 can configure sensors 510 to capture sensor data in a collaborative and/or synchronized manner, such that the sensor data can be utilized to perceive a driving environment surrounding the vehicle at any point in time.

Sensor interface 504 can include one or more of Ethernet, USB (universal serial bus), LTE (long term evolution) or cellular, WiFi, GPS, camera, CAN, serial (e.g., universal asynchronous receiver transmitter or UART), SIM (subscriber identification module) card, and other general purpose input/output (GPIO) interfaces. Host interface 505 may be any high speed or high bandwidth interface such as PCIe (peripheral component interconnect or PCI express) interface. Sensors 510 can include a variety of sensors that are utilized in an autonomous driving vehicle, such as, for example, a camera, a LIDAR device, a RADAR device, a GPS receiver, an IMU, an ultrasonic sensor, a GNSS (global navigation satellite system) receiver, an LTE or cellular SIM card, vehicle sensors (e.g., throttle, brake, steering sensors), and system sensors (e.g., temperature, humidity, pressure sensors), etc.

For example, a camera can be coupled via an Ethernet or a GPIO interface. A GPS sensor can be coupled via a USB or a specific GPS interface. Vehicle sensors can be coupled via a CAN interface. A RADAR sensor or an ultrasonic sensor can be coupled via a GPIO interface. A LIDAR device can be coupled via an Ethernet interface. An external SIM module can be coupled via an LTE interface. Similarly, an internal SIM module can be inserted onto a SIM socket of sensor unit 500. The serial interface such as UART can be coupled with a console system for debug purposes.

Note that sensors 510 can be any kind of sensors and provided by various vendors or suppliers. Sensor processing module 501 is configured to handle different types of sensors and their respective data formats and communication protocols. According to one embodiment, each of sensors 510 is associated with a specific channel for processing sensor data and transferring the processed sensor data between host system 110 and the corresponding sensor. Each channel includes a specific sensor processing module and a specific data transfer module that have been configured or programmed to handle the corresponding sensor data and protocol, as shown in FIG. 5B.

Referring now to FIG. 5B, sensor processing modules 501A-501C are specifically configured to process sensor data obtained from sensors 510A-510C respectively. Note that sensors 510A-510C may the same or different types of sensors. Sensor processing modules 501A-501C can be configured (e.g., software configurable) to handle different sensor processes for different types of sensors. For example, if sensor 510A is a camera, processing module 501A can be figured to handle pixel processing operations on the specific pixel data representing an image captured by camera 510A. Similarly, if sensor 510A is a LIDAR device, processing module 501A is configured to process LIDAR data specifically. That is, according to one embodiment, dependent upon the specific type of a particular sensor, its corresponding processing module can be configured to process the corresponding sensor data using a specific process or method corresponding to the type of sensor data.

Similarly, data transfer modules 502A-502C can be configured to operate in different modes, as different kinds of sensor data may be in different size or sensitivities that require different speed or timing requirement. According to one embodiment, each of data transfer modules 502A-502C can be configured to operate in one of a low latency mode, a high bandwidth mode, and a memory mode (also referred to as a fixed memory mode).

When operating in a low latency mode, according to one embodiment, a data transfer module (e.g., data transfer module 502) is configured to send the sensor data received from a sensor to the host system as soon as possible without or with minimum delay. Some of sensor data are very sensitive in terms of timing that need to be processed as soon as possible. Examples of such sensor data include vehicle status such as vehicle speed, acceleration, steering angle, etc.

When operating in a high bandwidth mode, according to one embodiment, a data transfer module (e.g., data transfer module 502) is configured to accumulate the sensor data received from a sensor up to a predetermined amount, but is still within the bandwidth the connection between the data transfer module and the host system 110. The accumulated sensor data is then transferred to the host system 110 in a batch that maximum the bandwidth of the connection between the data transfer module and host system 110. Typically, the high bandwidth mode is utilized for a sensor that produces a large amount of sensor data. Examples of such sensor data include camera pixel data.

When operating in a memory mode, according to one embodiment, a data transfer module is configured to write the sensor data received from a sensor directly to a memory location of a mapped memory of host system 110, similar to a shared memory page. Examples of the sensor data to be transferred using memory mode include system status data such as temperature, fans speed, etc.

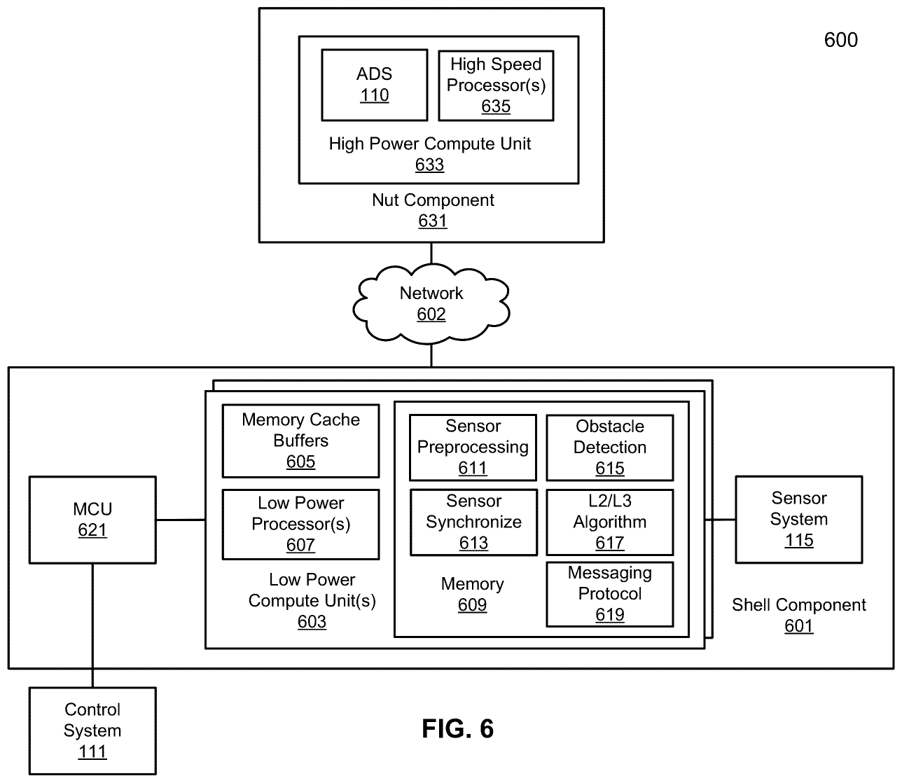

FIG. 6 is a block diagram illustrating a computing platform 600 based on the primary and secondary architecture according to one embodiment. Computing platform 600 can represent ADS 110 of FIG. 1. As shown, computing platform 600 can include a secondary component 601 and a primary component 631. Secondary component 601 can be communicatively coupled to primary component 631 over network 602. Network 602 can be a cellular wireless network or can be a physical high speed link. In one embodiment, the high speed link includes a LAN or a compute express link (CXL). CXL refers to a cache-coherent interconnect for processors, memory expansion and accelerators. Using the CXL protocols (e.g., CXL.io, CXL.cache, and/or CXL.mem), the secondary component can coherently access a memory space of a processor of the primary component and/or provide coherent or non-coherent access to memory buffer of secondary component from the processor of the primary component.

The secondary component can represent a low power compute unit (LPCU) having advanced driving assistance systems (ADAS) of the ADV, where the ADAS can perform L2/L3 radar assisted cruise control, autonomous parking, and/or lane guidance, etc. The LPCU can include L2/L3 perception and can interface with control and sensor systems of the ADV. The primary component can include a high power compute unit (HPCU) that represents the autonomous driving system (ADS), where the ADS can perform L4/L5 autonomous driving functions. As shown, the primary and secondary architecture decouples the hardware of sensor and controls of the ADV (L2/L3), from the hardware of the ADS functions (L4/L5) of the ADV. In some embodiments, the hardware for the ADS can also perform L2/L3 functions.

In one embodiment, secondary component 601 includes a low power compute unit (LPCU) 603, microcontroller (MCU) 621, and sensor system 115. LPCU 603 can be configured to collect sensor data from sensor system 115 and perform ADAS functions by sending control commands to MCU 621. MCU 621 can communicatively couple LPCU 603 to control system 111. In one embodiment MCU 621 communicates control commands directly to a controller area network (CAN) bus of the ADV. In one embodiment, LPCU 601 can operate at low power, where low power can be below a predetermined power threshold, e.g., 200 Watts.

In one embodiment, LPCU 601 includes memory cache buffers 605, low power processors 607, and memory 609. In one embodiment, a buffer of memory cache buffers 605 can buffer sensor data from sensor system 115, where the sensor data can be retrieved by primary component 631 for ADS functions. In one embodiment, the sensor data are sent via a messaging queue or a publish-subscribe message model. For example, for the publish-subscribe messaging model, HPCU can subscribe with LCPU to receive sensor data messages. LCPU can publish sensor data when available and include an attribute to the sensor data indicating the sensor data are data related to the sensor. When subscribed, the posted data are received by HPCU. In another embodiment, data are queued in memory cache buffers 605 for HPCU to consume. In another embodiment, HPCU polls data directly from memory cache buffers 605. In one embodiment, the sensor data are stored as time-series snapshots, where each snapshot represents a frame of data for the plurality of sensors at an instance in time.

In one embodiment, a buffer of memory cache buffers 605 can buffer control command signals from either LPCU and/or HPCU. For example, HPCU of primary component 631 can send control commands to LPCU. The requested commands can be queued at memory cache buffers 605, where LPCU 603 can send the control commands in queue to control system 111 to operate the ADV. In one embodiment, memory cache buffers 605 include one or more circular buffers that operate at constant time, e.g., O(1). In one embodiment, sensor data and/or control commands are stored in the circular buffers in a first-in-first-out (FIFO) manner. In one embodiment, the circular buffers have fixed length. In one embodiment, the lower power processors can include processors based on the reduced instruction set computer (RISC) architecture. An example of a low power processor can be an ARM© processor.

In one embodiment, memory 609 includes sensor preprocessing 611, sensor synchronize 613, obstacle detection 615, L2/L3 algorithms 617, and messaging protocol 619 modules. Sensor preprocessing 611 can process sensor data before the sensor data are placed in memory cache buffer 605. Examples of data processing functions include data precision conversion (e.g., 8 bits to 6 bits), data format conversion (e.g., red-green-blue (RGB) to YCbCr or any other color spaces), filtering, etc. Sensor synchronize 613 can synchronize sensor data from the various sensors. For example, different sensors can provide data at different time frequencies, e.g., camera at 30 frames per seconds, LIDAR may be at 10 frames per seconds, etc. Sensor synchronize 613 can provide time-series snapshots for the plurality of sensors at a particular frame rate. In one embodiment, sensor synchronize 613 can drop some sensor data frames that are obtained at a high rate and/or interpolate sensor data frames that are obtained at lower rates to synchronize the sensor data to a particular frame rate. Obstacle detection 615 can detect curbs, lane lines, and/or other vehicles/obstacles for lane guidance and/or automatic parking. L2/L3 algorithm 617 can include algorithms that queues control commands for the ADV to perform L2/L3 tasks. Obstacle detection 615 and/or L2/L3 algorithm 617 can perform low level cognitive L2/L3 functions. Messaging protocol 619 module can configure memory cache buffers 605 to use one or more messaging protocol (e.g., queue, poll, or publish-subscribe, etc.) to send sensor data. Some of modules 611-619 may be integrated together as an integrated module.

In one embodiment, LPCU 603 includes a primary LPCU and a redundant LPCU to take over when primary LPCU malfunctions. LPCU 603 can be implemented as a FPGA, SoC, an edge device, or mixture of them to adapt to customized sensors configurations. In some embodiments, if the primary component 631 is not responsive (or malfunctions), secondary component 601 (or LPCU 603) can assume the autonomous driving operations limited to the ADAS L2/L3 functionalities. Here, the secondary component 601 can provide a low latency, low level cognition, low power consumption, and a low failure rate.

Primary component 631 can include a high power (e.g., high speed) compute unit (HPCU) 633. In one embodiment, HPCU 631 HPCU 633 can be built using commercially available off-the-shelf (COTS) components and can operate at high power, where high power can be above a predetermined power threshold, e.g., 800 Watts. In one embodiment, HPCU 633 can operate on-premise and/or on-cloud, or a hybrid of both with certain functionalities on-cloud. The cloud infrastructure can be private or semi-private, e.g., provided over the Internet or a private internal network to only selected operators instead of the general public. HPCU 633 can include high speed processor(s) 635, ADS 110, and various graphical/deep learning accelerators. In one embodiment, HPCU 633 can operate at 1000 tera-operations per second or higher. Similar to consumer IT computing platforms, the primary component (or the HPCU) can be upgraded on an annually, or bi-annually basis, etc. without modifying the secondary component. Here, primary component 631 can feature a higher latency, higher level cognition, higher power consumption and higher allowed failure rate. Because primary component 631 is decoupled from secondary component 601, primary component 631 can be upgraded when new hardware components become available. In some embodiments, the secondary component represents a redundant driving system. For example, if the primary component is not responsive, the secondary component can assume the autonomous driving operations limited to the ADAS functionalities.

Note that some or all of the components as shown and described above may be implemented in software, hardware, or a combination thereof. For example, such components can be implemented as software installed and stored in a persistent storage device, which can be loaded and executed in a memory by a processor (not shown) to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the disclosure also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present disclosure are not described with reference to any particular programming language. It will be appreciated that a variety of programming languages may be used to implement the teachings of embodiments of the disclosure as described herein.

In the foregoing specification, embodiments of the disclosure have been described with reference to specific exemplary embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

1. A secondary component of a primary-secondary autonomous driving system, comprising:
a plurality of sensors configured to sense a surrounding environment of an autonomous driving vehicle (ADV);
a low power compute unit (LPCU) configured to:
obtain sensor data from the plurality of sensors;
synchronize and preprocess the sensor data to obtain processed sensor data; and
detect obstacles using a machine learning pipeline for assistive driving operations; and
a microcontroller configured to send control commands to a control system of the ADV, wherein the control commands are generated by the LPCU or by a high power compute unit (HPCU) of a primary component of the primary-secondary autonomous driving system.

2. The secondary component of claim 1, wherein the LPCU has low latency, low level cognition, low power consumption and a low failure rate.

3. The secondary component of claim 1, wherein the LPCU performs at least one of: assisted cruise control, lane guidance, or autonomous parking.

4. The secondary component of claim 1, wherein the secondary component is communicatively coupled to the primary component via a high speed link, wherein the high speed link includes a compute express link (CXL) interface.

5. The secondary component of claim 1, wherein the secondary component is communicatively coupled to the primary component via wireless cellular communication.

6. The secondary component of claim 1, further comprising a memory buffer, wherein the sensor data are stored in the memory buffer in a first-in-first-out manner.

7. The secondary component of claim 6, wherein the memory buffer includes a circular memory buffer, wherein the primary component replaces control commands on the LCPU circular memory buffer before the commands are sent to the microcontroller.

8. The secondary component of claim 1, wherein the data in a memory buffer is transferred to the primary component via a publish and subscribe protocol.

9. The secondary component of claim 1, wherein the LPCU comprises at least one of: a field programmable gate array (FPGA), a system on a chip (SOC), or an edge device.

10. The secondary component of claim 1, wherein the LPCU is operable independent of the primary component to provide driver assist features to the ADV.

11. A primary-secondary autonomous driving system, comprising:
a primary component; and
a secondary component coupled to the primary component via a high speed link,
wherein the primary component comprises a high power compute unit (HPCU) and the HPCU comprises:
one or more processors, and a memory coupled to the one or more processors to perform autonomous driving operations,
wherein the secondary component comprises:
a plurality of sensors configured to sense a surrounding environment of an autonomous driving vehicle (ADV);
a low power compute unit (LPCU) configured to:
obtain sensor data from the plurality of sensors;
synchronize and preprocess the sensor data to obtain processed sensor data; and
detect obstacles using a machine learning pipeline for assistive driving operations; and
a microcontroller configured to send control commands to a control system of the ADV, wherein the control commands are generated by the LPCU or by the HPCU of the primary component.

12. The system of claim 11, wherein the LPCU has low latency, low level cognition, low power consumption and a low failure rate.

13. The system of claim 11, wherein the LPCU performs at least one of: assisted cruise control, lane guidance, or autonomous parking.

14. The system of claim 11, wherein the high speed link includes a compute express link (CXL) interface.

15. The system of claim 11, wherein the autonomous driving operations comprises prediction, decision, or planning operations.

16. The system of claim 11, further comprising a memory buffer, wherein the sensor data are stored in the memory buffer in a first-in-first-out manner.

17. The system of claim 16, wherein the memory buffer includes a circular memory buffer, wherein the primary component replaces control commands on the LCPU circular memory buffer before the commands are sent to the microcontroller.

18. The system of claim 11, wherein the data in a memory buffer is transferred to the primary component via a publish and subscribe protocol.

19. The system of claim 11, wherein the LPCU comprises at least one of: a field programmable gate array (FPGA), a system on a chip (SOC), or an edge device.

20. The system of claim 11, wherein the LPCU is operable independent of the primary component to provide driver assist features to the ADV.
